(19) United States
(12) Patent Application Publication
(10) Pub. No.: US 2002/0195763 A1
(43) Pub. Date: Dec. 26, 2002

(54) Food cutting board assembly

(76) Inventor: William Benjamin, Paramount, CA (US)

Correspondence Address: Vic Y. Lin, Myers, Dawes & Andras LLP, Suite 1150, 19900 MacArthur Blvd., Irvine, CA, 92612, US

(21) Appl. No.: 09/885,651

(22) Filed: Jun. 20, 2001

(51) Int. Cl. B23Q 3/00

(52) U.S. Cl. 269/289 R

(57) ABSTRACT

A food cutting board apparatus includes a cutting board with an aperture sized to receive a colored indicator. The aperture is preferably located adjacent to a corner of the board. The indicator preferably comprises a ring with a hollow cavity to enable the apparatus to be hung when not in use. A cutting board system comprises the cutting board and a plurality of differently colored indicators, each with a substantially similar structure corresponding to the shape of the board aperture. A multi-board assembly includes multiple cutting board apparatuses held by a receptacle tray. Each cutting board apparatus includes notches along the edges to provide openings for discarded food items and liquids to be disposed in a space defined by the tray. The tray includes a divider which separates the board apparatuses and divides the space therein into separate compartments.

### BACKGROUND OF THE INVENTION

1. Field of the Invention

The present invention relates generally to cutting board assemblies for food.

2. Description of Prior Art and Related Information

Cutting boards are typically used wherever food is being prepared, whether in restaurants or at home. It is likely that in between washes, a single board may be used several times to support different types of foods. Conventional boards present health hazards as they provide a platform for sharing germs. For example, a conventional cutting board may be used for cutting raw meat and, subsequently, for cutting fruit. Without a thorough wash in between the placement of different foods, germs are likely to be transferred to the subsequently disposed foods, which may be especially hazardous if such subsequently placed foods are not to be cooked, as with fruits, salads, desserts, etc.

In restaurants where large quantities of food must be prepared in a short amount of time, washing a cutting board in between each placement of food can be extremely time consuming and, thus, impractical. The demand for prompt service, however, is countered by the need for sanitation, especially in view of regulations which may soon be passed by the National Sanitary Foundation (NSF) with respect to the handling of kitchen utensils and equipment in restaurants. The NSF may rule that restaurant kitchens must have their own internal color system for designating particular cutting boards to be used for particular types of foods.

Though it may be possible to provide cutting boards in different colors, a board entirely composed of a single color other than white is unsightly. For restaurants which may have food cut and prepared in front of the guests, using a cutting board that is entirely yellow, for example, would be highly undesirable.

Therefore, what is needed is a color coded cutting assembly that is both cost effective and aesthetically pleasing.

### SUMMARY OF THE INVENTION

The present invention provides structures and methods which overcome the deficiencies in the prior art.

In one aspect, a cutting board assembly is provided. The assembly, or apparatus, comprises a cutting board and a colored indicator. The cutting board comprises an aperture with a first shape. The colored indicator has a second shape in conformity with the first shape. The colored indicator is disposed at least in part within the aperture. The colored indicator may comprise a ring in a preferred embodiment. Alternatively, the colored indicator may comprise a solid plug with indicia disposed on an end surface. The second shape of the plug may comprise a food shape, namely the shape of a food item belonging in the food category for which the apparatus is designated by color. The cutting board itself may also comprise indicia. Using a colored indicator allows cutting board assemblies according to the invention to be color coded without having to color the board itself. The cutting board then is preferably white, which is more aesthetically pleasing. The colored indicator preferably comprises a non-white color.

In another aspect, a cutting board assembly comprises a cutting board having a first board surface, an opposite second board surface, and a bore extending from the first surface to the second surface. The assembly further comprises a colored indicator disposed in the bore of the cutting board. In a preferred embodiment, the colored indicator has a first end flush with the first board surface and second end flush with the second board surface. The colored indicator may comprise a cylinder having an opening, the cylinder being press fit into the bore of the cutting board. The cutting board comprises at least one corner. The bore is disposed adjacent to the corner.

A cutting board system is provided. The system comprises a cutting board having an aperture with a first shape, and a plurality of differently colored indicators. Each indicator has a second shape in conformity with the first shape such that each indicator fits in the aperture. The system further comprises a tray for supporting the cutting board.

A multi-board assembly is also provided. The multi-board assembly comprises a first cutting board having a first aperture, a first colored indicator disposed in the first aperture, a second cutting board having a second aperture, the second cutting board being disposed adjacent to the first cutting board, a second colored indicator disposed in the second aperture, and a receptacle tray supporting the first cutting board and the second cuffing board. The receptacle tray defines a space underneath the first cutting board and the second cutting board. The first colored indicator is differently colored than the second colored indicator. The receptacle tray further comprises a divider separating the first cutting board from the second cutting board. The divider comprises a wall extending vertically from a floor of the receptacle tray. The divider separates the space into a first compartment underneath the first cutting board and a second compartment underneath the second cutting board.

A method for color coding food cutting boards is also provided. The method comprises providing a cutting board, forming a hole with a shape in the cutting board, providing a plurality of differently colored indicators, and configuring each indicator with a substantially similar structure in conformity with the shape of the hole of the cutting board. The method further comprises providing a tray for supporting the cuffing board. The method further comprises providing additional cuffing boards, and forming a hole in each additional cutting board substantially similar to the hole in the first cutting board.

In summary, a food cutting board apparatus includes a cutting board with an aperture sized to receive a colored indicator. The aperture is preferably located adjacent to a corner of the board. The indicator preferably comprises a ring with a hollow cavity to enable the apparatus to be hung when not in use. A cutting board system comprises the cutting board and a plurality of differently colored indicators, each with a substantially similar structure corresponding to the shape of the board aperture. A multi-board assembly includes multiple cutting board apparatuses held by a receptacle tray. Each cutting board apparatus includes notches along the edges to provide openings for discarded food items and liquids to be disposed in a space defined by the tray. The tray includes a divider which separates the board apparatuses and divides the space therein into separate compartments.

The invention, now having been briefly summarized, may be better appreciated by the following detailed description and reference to the figures.

### BRIEF DESCRIPTION OF THE DRAWINGS

FIG. 1 is an exploded view of a preferred embodiment of a cutting board assembly;

FIG. 2 is a top plan view of the preferred embodiment of the cutting board assembly;

FIG. 3 is a cross-sectional view taken along lines 3′-3′ of FIG. 2;

FIG. 4 is a top plan view of a further preferred embodiment of the cutting board assembly having a solid indicator;

FIG. 5 is a top plan view of a further preferred embodiment of the cutting board assembly having a solid indicator;

FIG. 6 is a perspective view of a further alternate indicator;

FIG. 7 is a schematic view of a preferred cutting board system; and

FIG. 8 is an exploded, perspective view of a preferred multi-board assembly.

### DETAILED DESCRIPTION OF THE PREFERRED EMBODIMENTS

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

In FIGS. 1, 2 and 3, a preferred embodiment of a food cutting board assembly is illustrated and designated generally by the reference numeral 10. In FIG. 1, the cutting board assembly, or simply apparatus, 10 comprises a cutting board 20 having a first surface 22 and an opposite second surface 24. Both surfaces 22, 24 are generally flat and adapted for supporting various foods to be cut. The cutting board 20 is generally solid with a thickness “A”. An aperture, or bore, 26 is defined in the cutting board 20, extending from the first surface 22 to the second surface 24. The aperture 26 has a particular aperture shape 28 that is designed to receive a similarly shaped colored indicator 30. As examples and not by way of limitations, the cutting board 20 may be composed of polyethylene and polypropylene while the indicator 30 may also be composed of polyethylene and polypropylene.

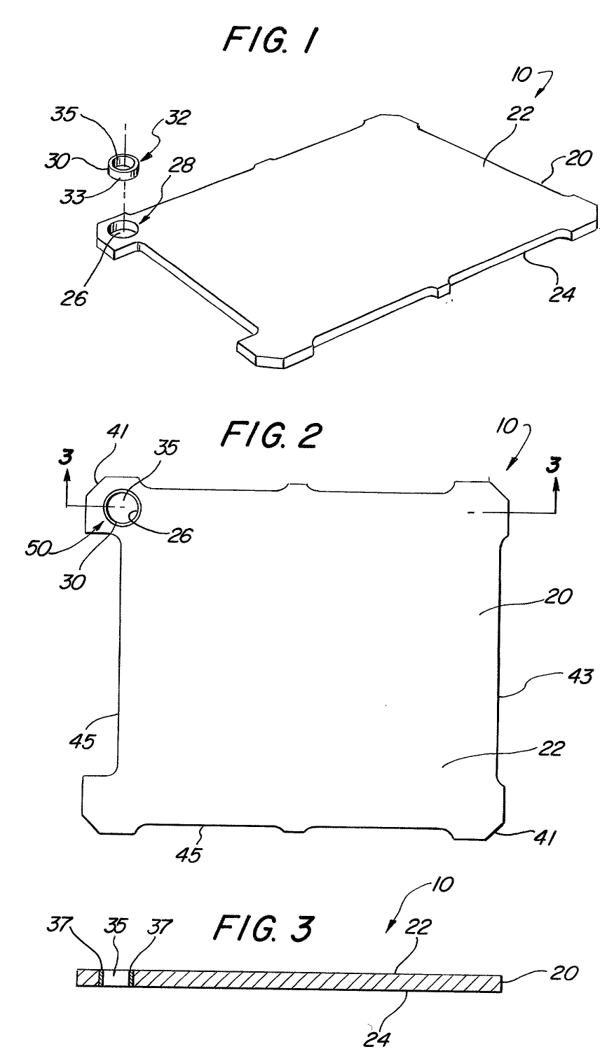

The colored indicator 30 has an indicator shape 32 in conformity with the aperture shape 28. In the preferred embodiment, the colored indicator 30 comprises a cylinder, or ring, 33 having a hollow cavity, or hole, 35. The indicator 30 is preferably cylindrical to facilitate hanging of the apparatus 10. In particular, the ring 30 is disposed in the aperture 26 located adjacent to a corner 41 of the cutting board 20. In the preferred embodiment shown in FIG. 2, the cutting board 20 is generally shaped in the form of a rectangle having four corners 41 and four edges 43. Notches 45 are defined along the edges 43 and adapted for allowing drippings from foods to run off the surface 22 or 24, as will be further described below in connection with a receptacle tray.

With the aperture 26 and ring 30 preferably disposed adjacent to any one of the corners 41, the hole 35 of the ring 30 provides an opening for conveniently receiving a hook, for example. Thus, the aperture 26 in combination with the ring 30 collectively form a storage mechanism 50 that enables the apparatus 10 to be hung vertically when not in use, thereby occupying minimal space. For busy restaurant kitchens where horizontal work space is limited, it will be appreciated that several cutting board assemblies 10 according to the invention may be hung when unused, thereby providing maximum work space for only those utensils and equipment in use.

In FIG. 3, the colored indicator 30 has a pair of ends 37, one adjacent to the first surface 22 of the cutting board 20, and the other adjacent to the second surface 24. The ends 37 are preferably flush with the surfaces 22, 24. The two-dimensional shape, or perimeter, of the ends 37, e.g., circular in the preferred embodiment, defines the indicator shape 32 which is in conformity with the aperture shape 28. Alternatively stated, the outer edge of the indicator 30 conforms to the inner edge of the board aperture 26. In the preferred embodiment wherein the indicator 30 comprises a cylinder, the indicator ends 37 thus comprise annular surfaces.

One preferred method of assembling the apparatus 10, and thereby color coding the cutting board 20, is to heat the cutting board 20 in hot water, for example, while cooling the indicator 30, for example, in a freezer. The heat causes the cutting board 20 to slightly expand, thereby enlarging the board aperture 26. Cooling the indicator 30 generally causes it to decrease slightly in size. In their modified states, the cooled indicator 30 may be disposed in the heated board 20 with the enlarged aperture 26. As each component 20 and 30 returns to room temperature, the indicator 30 will expand into the shrinking board aperture 26, resulting in a tight fit that is not easily removable by hand.

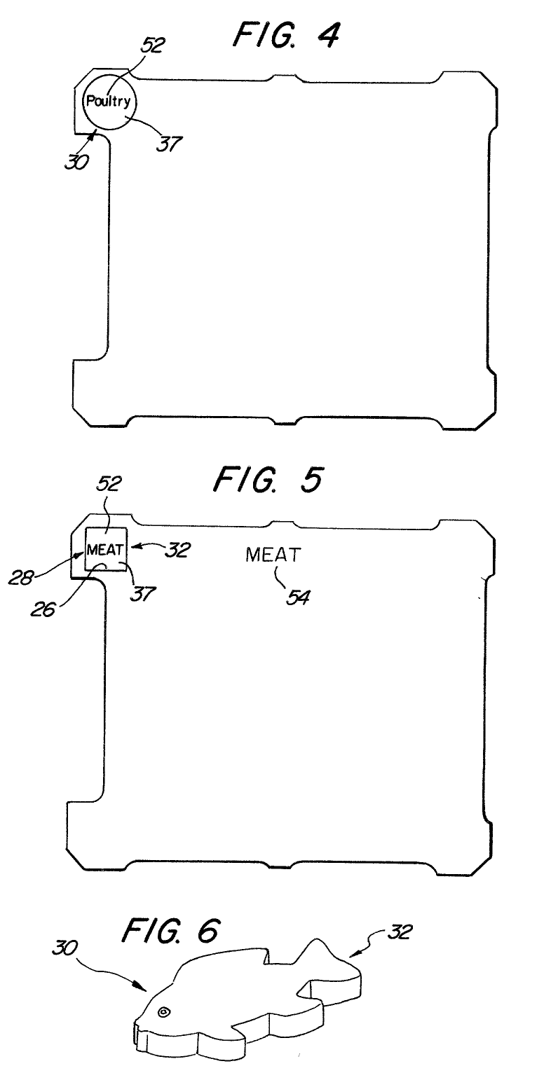

It will be appreciated that the indicators 30 may be provided in a variety of configurations. For example, in FIG. 4, the indicator 30 may be solid in which case the indicator ends 37 comprise flat surfaces with substantial surface area upon which indicia 52 may be disposed to indicate, for example, the type of food to be used with the apparatus 10. This indicia 52 serves to reinforce the visual indication already provided by the color of the indicator 30.

The indicator 30 may also be provided in a variety of indicator shapes as defined by the two-dimensional shape of its ends 37. In FIG. 5, for example, the indicator 30 may have a polygonal indicator shape 32 as defined by the ends 37, shown as square in this embodiment. Accordingly, the cutting board 20 comprises an aperture 26 with a corresponding square aperture shape 28 to receive the indicator 30. In addition to indicia 52 disposed on the indicator 30, the cutting board 20 may also have indicia 54, for example, to designate the type of food to be used with the apparatus 10. In an alternative embodiment, the indicator 30 may have flat surface ends 37 and, yet, a hollow interior to save cost of materials.

In FIG. 6, the indicator 30 may have an asymmetrical, non-polygonal indicator shape 32. In particular, the indicator shape 32 may resemble a food item belonging in the food category for which the apparatus 10 is to be used. Thus, the indicator shape 32 may resemble a fish as shown so as to designate the category of seafood, for example. As further examples, the indicator shape 32 may also comprise an apple to designate fruits and/or vegetables, a drumstick to designate poultry, or any other common food item which would visually designate its corresponding food category.

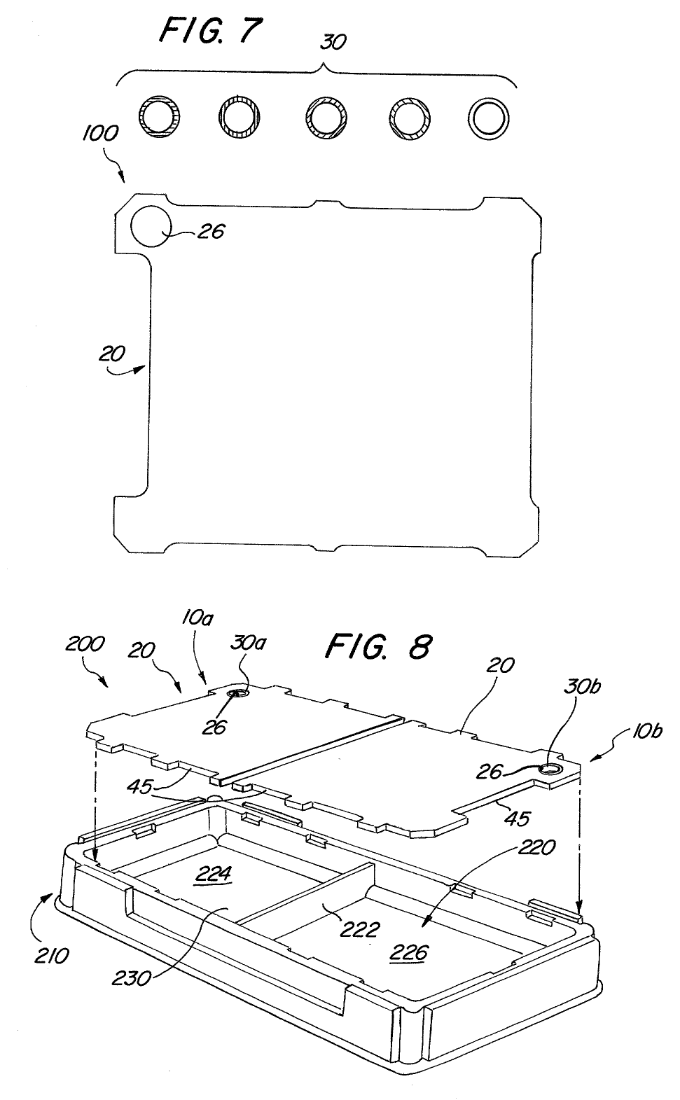

In FIG. 7, it will be appreciated that a cutting board system 100 is also provided incorporating the cutting board 20 and the indicators 30 according to the invention. The system 100 comprises the cutting board 20 with at least one aperture 26 and a plurality of differently colored indicators 30. The indicators 30 share a substantially similar structure which is configured to fit in the similarly shaped aperture 26 of the cutting board 20.

An advantage of the system 100 is that it may be sold as a kit to the user, providing flexibility while minimizing costs. Since the indicators 30 are relatively cheaper to manufacture than the boards 20, such a system 100 enables a user to merely purchase a kit comprising a single board 20 with several indicators 30, thus leaving the option of color coding the board 20 up to the user. Such flexibility is not found in other cutting boards which, for example, are entirely composed of a single color. In the system 100, the board 20 preferably comes uninstalled, thereby giving the user the option of installing a desired colored indicator 30. It will be appreciated that using colored indicators 30 enables cutting boards 20 according to the invention to be color coded without having to color the board itself. The cutting board 20 may then be preferably white, which is more aesthetically pleasing.

Instead of merely a single board 20, the system 100 may comprise a plurality of boards 20, each having an identical, or substantially similar, aperture 26 which is shaped according to the shape of the indicators 30. Thus, any of the colored indicators 30 may fit in any aperture 26. The boards 20 may have identical or different structures.

It will be appreciated that the cutting board apparatus 10 according to the invention enables greater manufacturability since the cutting boards 20 may all be similarly made. A single structure and a single color, preferably white, is all that is minimally required for the cutting boards 20. Variability is provided in the differently colored indicators 30 which are less expensive to produce. Users and guests at restaurants will appreciate the aesthetics of the apparatus 10 since the board 20 remains white.

Greater flexibility is also provided in the apparatus 10 than cutting boards which are composed of entirely one color. For example, a user desiring a particularly color coded cutting board may simply purchase the system 100, described above and shown in FIG. 7, and install the desired colored indicator 30 into the cutting board 20. Otherwise, the user would have to hunt for a specifically colored board, or purchase an entire kit of differently colored boards just to obtain the one desired board.

In FIG. 8, a multi-board assembly 200 is provided. The assembly 200 comprises a first cutting board apparatus 10a and a second cutting board apparatus 10b as described above. Thus, each apparatus 10a, 10b comprises a cutting board 20 and a corresponding indicator 30a, 30b disposed in the board aperture 26. The first colored indicator 30a may have a similar or different color than the color of the second colored indicator 30b.

A receptacle tray 210 holds the apparatuses 10a, 10b in a juxtaposed relationship. The tray 210 defines a space 220 for receiving any drippings, cut off food portions, or any other discarded portions. A divider 222 divides the space 220 into a first compartment 224 beneath the first cutting board apparatus 10a, and a second compartment 226 beneath the second cutting board apparatus 10b, thereby preventing any mixing or cross-contamination therebetween. The divider 222 preferably comprises a wall extending vertically from a floor 230 of the tray 210. The divider 222 further separates the first apparatus 10a from the second apparatus 10b, preventing any direct contact between the apparatuses 10a, 10b.

As referenced earlier, each cutting board 20 includes notches 45 defined along its edges 43. The notches 45 provide openings for discarded food portions and drippings to be disposed into the space 220 of the receptacle tray 210. The multi-board assembly 200 provides an expanded work surface as well as means for collecting liquids and any unwanted or discarded food particles. Furthermore, with the placement of the divider 222, separate cutting board apparatuses 10a, 10b may be employed. The apparatuses 10a, 10b may be similarly or differently color coded depending upon the needs of the user, thus providing flexibility and convenience.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what incorporates the essential idea of the invention.

What is claimed is:

1. A cutting board assembly comprising:
a cutting board comprising an aperture with a first shape; and
a colored indicator having a second shape in conformity with the first shape, the colored indicator being disposed at least in part within the aperture.

2. The assembly of claim 1, wherein the colored indicator comprises a ring.

3. The assembly of claim 1, wherein the colored indicator comprises a solid plug.

4. The assembly of claim 3, wherein the plug comprises indicia.

5. The assembly of claim 3, wherein the second shape of the plug comprises a food shape.

6. The assembly of claim 1, wherein the cutting board comprises indicia.

7. The assembly of claim 1, wherein the cutting board is white.

8. The assembly of claim 6, wherein the colored indicator comprises a non-white color.

9. A cutting board assembly comprising:
a cutting board having a first board surface, an opposite second board surface, and a bore extending from the first surface to the second surface; and
a colored indicator disposed in the bore of the cutting board, the colored indicator having a first end flush with the first board surface and a second end flush with the second board surface.

10. The assembly of claim 9, wherein the colored indicator comprises a cylinder having an opening, the cylinder being press fit into the bore of the cutting board.

11. The assembly of claim 10, wherein:
the cutting board comprises at least one corner; and
the bore is disposed adjacent to the corner.

12. A cutting board system comprising:
a cutting board having an aperture with a first shape; and
a plurality of differently colored indicators, each indicator having a second shape in conformity with the first shape such that each indicator fits in the aperture.

13. The system of claim 12, further comprising a tray for supporting the cutting board.

14. A multi-board assembly comprising:
a first cutting board having a first aperture;
a first colored indicator disposed in the first aperture;
a second cutting board having a second aperture, the second cutting board being disposed adjacent to the first cutting board;
a second colored indicator disposed in the second aperture; and
a receptacle tray supporting the first cutting board and the second cutting board, the receptacle tray defining a space underneath the first cutting board and the second cutting board.

15. The assembly of claim 14, wherein the first colored indicator is differently colored than the second colored indicator.

16. The assembly of claim 14, wherein the receptacle tray further comprises a divider separating the first cutting board from the second cutting board.

17. The assembly of claim 16, wherein the divider comprises a wall extending vertically from a floor of the receptacle tray, the divider separating the space into a first compartment underneath the first cutting board and a second compartment underneath the second cutting board.

18. A method for color coding food cutting boards, comprising:
providing a cutting board;
forming a hole with a shape in the cutting board;
providing a plurality of differently colored indicators; and
configuring each indicator with a substantially similar structure in conformity with the shape of the hole of the cutting board.

19. The method in claim 18, further comprising providing a tray for supporting the cutting board.

20. The method in claim 18, wherein the cutting board comprises a first cutting board and the hole comprises a first hole, the method further comprising:
providing additional cutting boards; and
forming a hole in each additional cutting board substantially similar to the first hole.
